(19) United States
(12) Patent Application Publication
(10) Pub. No.: US 2014/0308085 A1
(43) Pub. Date: Oct. 16, 2014

(54) DRILL GUIDE FOR DRILLING TUBES OF DIFFERENT DIAMETERS

(71) Applicant: PARKER HANNIFIN MANUFACTURING FRANCE SAS, Annemasse (FR)

(72) Inventor: Cyril Chaillot, Orgeres (FR)

(73) Assignee: PARKER HANNIFIN MANUFACTURING FRANCE SAS, Annemasse (FR)

(21) Appl. No.: 14/250,749

(22) Filed: Apr. 11, 2014

(30) Foreign Application Priority Data
Apr. 12, 2013 (FR) 1353341

(51) Int. Cl. B23B 47/28

(52) U.S. Cl. CPC B23B 47/281
USPC 408/105

(57) ABSTRACT

A drill guide for drilling tubes of a plurality of diameters, the guide comprising at least a first half-body and a second half-body each of which has a first face and a second face that are mutually opposite, which half-bodies are connected together by at least one hinge in such a manner that the two half-bodies can move relative to each other between a first closed position in which the first faces of the half-bodies face each other, and a second closed position in which the second faces of the half-bodies face each other in order to form housings suitable for receiving tubes of different diameters.

The present invention relates to a drill guide for drilling tubes of different diameters.

In order to form a fluid transfer circuit, it may be necessary to drill holes in tubes that are to make up the circuit for the purposes of:
forming branch connections as described in Document EP-A-0 575 225; or
receiving studs enabling a coupling to be fastened as described in Document EP-A-1 085 245.

Such holes are drilled on the site where the circuit is being installed by means of a sharp tool such as a drill bit mounted in the chuck of a drill.

In order to make it easier to make the holes, in particular in order to position the bit accurately and avoid the tip of the bit sliding on the surface of the tube, drill guides are known that enable the bit to be guided while drilling the hole.

Document U.S. Pat. No. 3,589,825 describes such a drill guide constituted by a block having a first series of bores formed therein to receive tubes of different diameters and a second series of bores extending transversely relative to the bores in the first series in order to form drill bushings. It is necessary to thread the tube for drilling in the bore of the first series that has a diameter matching the diameter of the tube. Unfortunately, tubes can be very long (six meters) and the hole to be made may be located near the middle of the tube. It is therefore not very practical to put such a tube in position in the drill guide. In addition, the tube is not clamped in the drill guide so the vibration generated by operating the drill runs the risk of moving the tube relative to the drill bushing.

Document U.S. Pat. No. 5,800,099 describes a drill guide in the form of lock-grip pliers with one of the jaws being provided with a drill bushing. That drill guide is nevertheless also not very practical, since the pliers need to be adjusted on each occasion they are used as a function of the diameter of the tube to be drilled. Furthermore, it is not possible with a guide of that type to make through holes.

An object of the invention is to provide a drill guide that is more practical in use.

To this end, the invention provides a drill guide for drilling tubes of a plurality of diameters, the guide comprising at least a first half-body and a second half-body each of which has a first face and a second face that are mutually opposite, which half-bodies are connected together by at least one hinge in such a manner that the two half-bodies can move relative to each other between a first closed position in which the first faces of the half-bodies face each other, and a second closed position in which the second faces of the half-bodies face each other. Each of the first faces is provided with at least one open housing to receive a portion of a tube of a first diameter and each second face is provided with at least one open housing for receiving a portion of a tube of a second diameter. A cylindrical bore extends from one of the first and second faces of at least the first half-body in order to open out into the housing in the other of the faces of the first half-body so as to form a drill bushing.

Thus, the drill guide in its two closed positions defines at least two housings of different diameters enabling the drill guide to be mounted without any particular adjustment on tubes of corresponding diameters.

Advantageously, the second half-body is provided with a bore that is positioned to extend on the same axis as the bore in the first half-body when the half-bodies are in at least one of their closed positions.

This makes it possible to drill holes passing right through the tubes.

Preferably, the drill guide includes at least one holder member for holding the half-bodies in at least one of the closed positions and, advantageously, the holder member comprises an eyelet bolt having a nut and hinged to one of the half-bodies to move between two positions that are at 180° to each other so as to be capable of being received in a groove in the other half-body when the half-bodies are in either one of their closed positions.

Other characteristics and advantages of the invention appear on reading the following description of particular, non-limiting embodiments of the invention.

Reference is made to the accompanying drawings, in which:

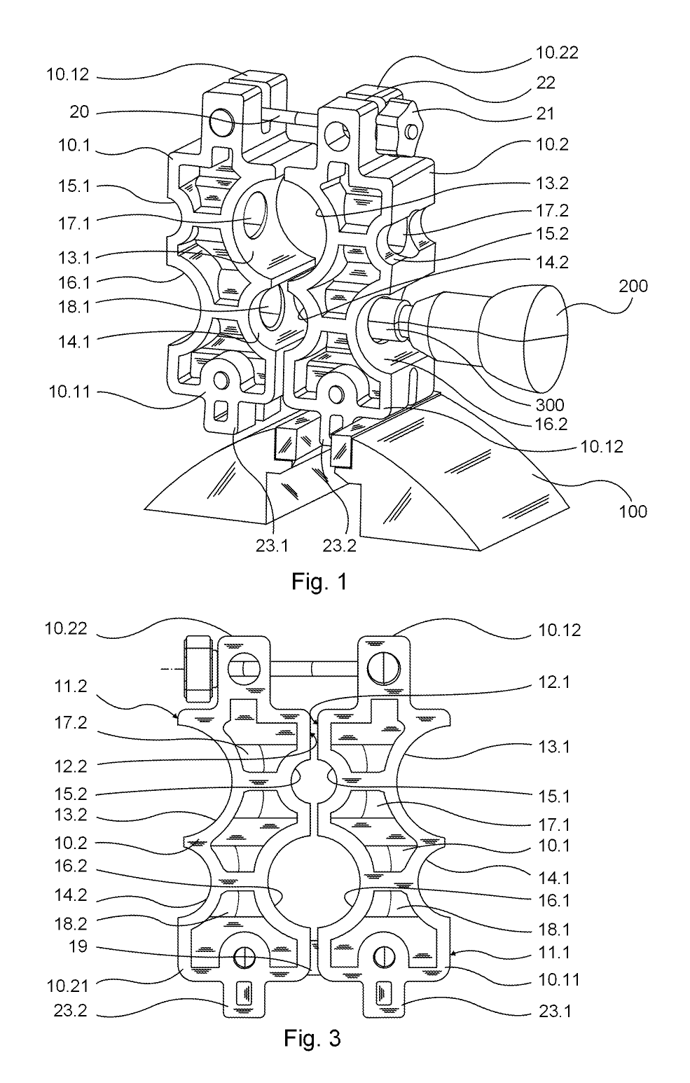

FIG. 1 is a perspective view of a drill guide in accordance with the invention, the drill guide being in a first closed position;

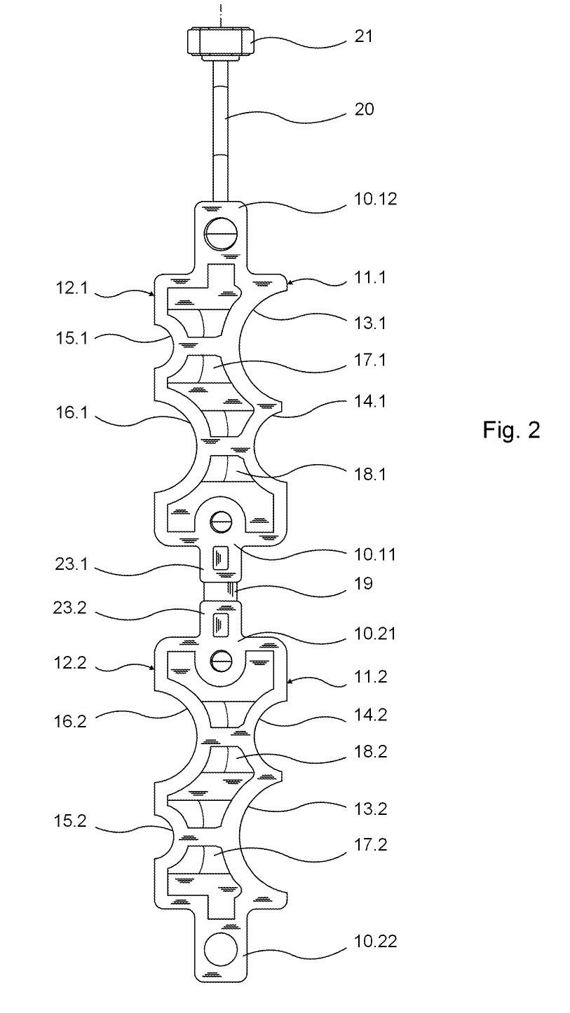

FIG. 2 is an elevation view of a drill guide in an open position; and

FIG. 3 is an elevation view of a drill guide in a second closed position.

With reference to the figures, the drill guide in accordance with the invention is arranged to enable tubes of different diameters to be drilled, in this example tubes of four different diameters.

The guide in accordance with the invention comprises at least a first half-body 10.1 and a second half-body 10.2, each having a first face 11.1, 11.2 and a second face 12.1, 12.2 that are mutually opposite.

Each of the first faces 11.1, 11.2 is provided with two open housings 13.1, 14.1, 13.2, 14.2 for receiving a portion of a tube of a first diameter and a portion of a tube of a second diameter, respectively.

Each of the second faces 12.1, 12.2 is provided with two open housings 15.1, 16.1, 15.2, 16.2 for receiving a portion of a tube of a third diameter and a portion of a tube of a fourth diameter.

The housings 13.1, 14.1 are in alignment respectively with the housings 15.1, 16.1 along a direction normal to the plane of the faces 11.1, 11.2, 12.1, 12.2. The housings 13.2, 14.2 are in alignment respectively with the housings 15.2, 16.2. The housings 13.1, 14.1, 15.1, 16.1, 13.2, 14.2, 15.2, 16.2 in this example are substantially semicircular in shape. More precisely, the depths of the housings 13.1, 14.1, 15.1, 16.1, 13.2, 14.2, 15.2, 16.2 are less than the radii of said housings.

Cylindrical bores 17.1, 17.2 extend between the first face 11.1, 11.2 and the second face 12.1, 12.2 of each half-body 10.1, 10.2 so as to open out into the housings 13.1, 15.1, 13.2, 15.2.

Cylindrical bores 18.1, 18.2 extend between the first face 11.1, 11.2 and the second face 12.1, 12.2 of each half-body 10.1, 10.2 to open out into the housings 14.1, 16.1, 14.2, 16.2.

In this example, all of the bores 17.1, 17.2, 18.1, 18.2 have the same diameter and form drill bushings. The bores 17.1, 17.2, 18.1, 18.2 extend perpendicularly to the mean planes of the faces 11.1, 11.2, 12.1, 12.2.

In this example, the half-bodies 10.1, 10.2 are connected together at one of their ends 10.11, 10.21. A link 19 in this example has one end hinged to the end 10.11 of the half-body 10.1 and an opposite end hinged to the end 10.21 of the half-body 10.2. The length and the freedom of movement of the link 19 are such that the two half-bodies 10.1, 10.2 can move relative to each other between a first closed position in which the first faces 11.1, 11.2 of the half-bodies 10.1, 10.2 face each other (FIG. 1) and a second position in which the second faces 12.1, 12.2 of the half-bodies 10.1, 10.2 face each other (FIG. 3). In the closed positions, each pair of facing housings defines a cylindrical housing of circular cross-section suitable for receiving a segment of tube to be drilled.

The two closed positions occur on opposite sides of a maximally open position (FIG. 2).

The guide has at least one holder member for holding the half-bodies 10.1, 10.2 in their two closed positions. The holder member comprises an eyelet bolt 20 provided with a nut 21 and hinged to the end 10.12 of the half-body 10.1 to move between two positions that are 180° apart from each other so as to be capable of being received in a groove 22 formed in the end 10.22 of the other half-body 10.2 when the two half-bodies 10.1, 10.2 are in either one of their closed positions.

The end 10.11, 10.21 of each half-body 10.1, 10.2 has a grip portion 23.1, 23.2 arranged to be capable of being clamped in a clamp device such as a vise.

In use, in order to drill a tube, the drill guide is closed on the tube so that the tube is received in the housings that correspond to its diameter. It can be understood that by tightening the nut 21 that bears against the half-body 10.2 at the end of the groove 22, it is possible to clamp the guide on the tube.

The grip portion of one of the two half-bodies is then clamped in a vise 100 in order to hold the guide and the tube in position so as to facilitate the drilling operation.

A sharp tool, such as a drill bit mounted on a drill 200 is then engaged in the bore that opens out into the housing so as to drill the tube. It should be observed that the two half-bodies 10.1, 10.2 are provided with bores that are positioned to extend on the same axis as each other when the half-bodies are in their closed positions, so that it is possible to drill right through a tube.

When the drill bit is of a diameter smaller than the diameter of the bore forming the drill bushing, the tool advantageously includes auxiliary means for guiding the bit in the bore. The auxiliary guide means in this example comprise a spacer 300 of cylindrical or tubular shape (like a bell) surrounding the bit, the spacer having a diameter that is slightly smaller than the diameter of the bore. In a variant, it is possible to use a stepped bit having a portion of larger diameter constituting the auxiliary guide means and a sharp portion of smaller diameter.

Naturally, the invention is not limited to the embodiments described but covers any variant coming within the ambit of the invention as defined by the claims.

In particular, the housings formed in the faces of the half-bodies may be of a section that is much less than a semicircle, and for example that may be equal to one-fourth of a circle. The numbers and the positions of the housings may also be modified.

Also in a variant, the bores may be arranged to receive interchangeable drill bushings.

1. A drill guide for drilling tubes of a plurality of diameters, the guide comprising at least a first half-body and a second half-body each of which has a first face and a second face that are mutually opposite, which half-bodies are connected together by at least one hinge in such a manner that the two half-bodies can move relative to each other between a first closed position in which the first faces of the half-bodies face each other, and a second closed position in which the second faces of the half-bodies face each other, each of the first faces being provided with at least one open housing to receive a portion of a tube of a first diameter and each second face being provided with at least one open housing for receiving a portion of a tube of a second diameter, a cylindrical bore extending from one of the first and second faces of at least the first half-body in order to open out into the housing in the other of the faces of the first half-body so as to form a drill bushing.

2. A guide according to claim 1, wherein the second half-body is provided with a bore that is positioned to extend on the same axis as the bore in the first half-body when the half-bodies are in at least one of their closed positions.

3. A guide according to claim 1, including auxiliary guide means for guiding a sharp drill tool in at least one of the bores.

4. A guide according to claim 3, wherein the auxiliary guide means comprise a spacer surrounding the sharp tool, the spacer having a diameter slightly smaller than the diameter of a bore.

5. A guide according to claim 3, wherein the sharp tool is a stepped drill bit having a portion of greater diameter forming the auxiliary guide means and a sharp portion of smaller diameter.

6. A guide according to claim 1, wherein the half-bodies are connected together by a link that is hinged to each of the half-bodies.

7. A guide according to claim 1, wherein at least one of the half-bodies has a grip portion arranged to be suitable for being clamped in a clamp device.

8. A guide according to claim 1, including at least one holder member for holding the half-bodies in at least one of the closed positions.

9. A guide according to claim 8, wherein the holder member comprises an eyelet bolt having a nut and hinged to one of the half-bodies to move between two positions that are at 180° to each other so as to be capable of being received in a groove in the other half-body when the half-bodies are in either one of their closed positions.
